(19) United States
(12) Patent Application Publication
(10) Pub. No.: US 2006/0270560 A1
(43) Pub. Date: Nov. 30, 2006

(54) Compositions for use in stored crop treatment aerosols and method and apparatus for application to stored crops

(76) Inventors: William A. Keim, Fort Wayne, IN (US); Michael J. Keim, Barberton, OH (US); John R. Keim, Barberton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/135,713

(22) Filed: May 24, 2005

(51) Int. Cl. A01N 25/04; A01N 25/16

(52) U.S. Cl. 504/366

(57) ABSTRACT

A method is disclosed for generating and delivering an aerosol of a unique composition for treating stored crops. One aspect of the invention is such a composition wherein at least 80% to 98% of the components thereof have a particle size value no greater than 10 microns, whereby nearly any type of aerosol generator may effectively generate the aerosol because the particle size distribution of the components eliminates the need for further particle size reduction. Another aspect of the invention is such a composition which includes components comprising solid carriers with stored crop treatments attached thereto. Preferably, a fine-grinding non-rotary ball mill produces the components at the desired particle size distribution. The solid carriers or other solid particles may provide a reduced caking tendency and may make the aerosol non-combustible regardless of the ignition source. The aerosol is typically generated at an ambient or near-crop-storage temperature, thus reducing fire hazards.

### BACKGROUND OF THE INVENTION

1. Technical Field

The invention relates generally to the use of aerosols in the application of chemical treatments to stored crops. One aspect of the invention relates to such aerosols using solid chemical treatments of a highly desirable particle size distribution. Another aspect of the invention relates to the use of such aerosols wherein the chemical treatments are attached to solid carriers in order to provide improved characteristics of the aerosol and delivery of the aerosol for application to the stored crops.

2. Background Information

Many crops are stored from the time of harvest until use. Chemical formulations are used to treat the stored crops in order to retain their commercial utility and appeal. The safe and efficient storage of agronomic crops such as potato tubers has been a long standing need in the agriculture industry. A variety of efforts over many years have been made to maximize the time period of storage and to extend the useful life of stored crops in order to maintain commercial viability. In general, such crop storage involves tightly controlled conditions, such as ventilation, temperature, humidity and light.

Harvested crops may be stored in many ways. Many crops are stored in boxes which are stored in a suitable building. Containers which are used to transport crops are also considered to be a form of crop storage. Potato tubers are in a dormant state upon harvesting and are typically stored in relatively large storage facilities as disclosed, for example, in U.S. Pat. No. 4,226,179 to Sheldon III and U.S. Pat. No. 4,887,525 to Morgan. These storage facilities typically provide controlled ventilation and protection from light to large piles of potatoes which are typically on the order of 16-20 feet high and as large of 130 feet wide and 400 feet in length.

Among the great variety of chemicals that can be used to treat stored crops are ethylene, ethylene oxide and CIPC, also known as isopropyl-3 chlorophenyl carbamate or chlorpropham. Ethylene is used to initiate de-greening and ripening of stored bananas, citrus fruit, honeydew melons and pears. Ethylene oxide is a fumigant and sterilant used to treat containers of imported crops. Ethylene and ethylene oxide provide effective crop treatment because they are gasses at the treatment conditions and are thus easily delivered to the exposed surfaces of the crops within the storage space. CIPC is used in aerosol form to treat stored potatoes in order to control sprouting. As is known in the art, CIPC provides an effective treatment because the very fine particles of CIPC forming the aerosol are capable of distribution throughout the potato storage in order to sufficiently treat all the exposed potato surfaces. Most commonly, the aerosols of CIPC are thermally generated (most typically in a liquid form) and carefully controlled in order to produce the very small particle size of the CIPC in the aerosol. It has long been recited in prior art that the particle size which is effective for use in stored crop treatment aerosols of CIPC is in the range of 1 to 10 microns or micrometers and preferably from 1 to 5 microns. For example, see U.S. Pat. No. 3,128,170 to Plant and US Patent Publication 2002/0136839 (Forsythe et al.).

While there is a long history of agricultural chemicals which are in the form of a dust or powder formulation, these formulations have particles which are larger than those noted immediately above so that the particles will effectively settle by the action of gravity. Thus, these formulations (for example, those used in the crop dusting of growing plants) have a relatively large particle size and are not suitable for the formation of a stored crop treatment aerosol. In addition, there are formulations of solids which are used with a liquid spray application such as water wherein solid particles are suspended in the liquid. While the solid particles have sizes smaller than those discussed with regard to the dust or powder formulations, these formulations contain agents which facilitate and ensure the suspension in the spray liquid, but which may not be desirable in a stored crop treatment aerosol.

The prior art includes various structures and methods for producing and delivering aerosols of CIPC to stored potatoes. U.S. Pat. No. 3,128,170 granted to Plant discloses an aerosol utilizing CIPC dissolved in an organic solvent. U.S. Pat. No. 4,226,179 granted to Sheldon III et al. discloses a method of applying CIPC which is micronized using ultrasonic nozzles and wherein either no solvent or small amounts of solvent are used in combination with the CIPC. U.S. Pat. No. 4,887,525 granted to Morgan discloses a method of reducing air flow in order to minimize CIPC particle losses. U.S. Pat. No. 5,723,184 granted to Yamamoto discloses a method of atomizing an organic compound such as CIPC to form an aerosol by introducing heated liquified CIPC under extreme pressure into a moving air mass within an atomization duct. An air stream is heated before reaching a nozzle from which the liquid CIPC is discharged into the vaporization duct and atomization or vaporization may be assisted by spraying the heated CIPC onto a heated plate or an ultrasonic vibrator. U.S. Pat. Nos. 5,935,660 and 6,068,888 granted to Forsythe et al., the latter being a continuation of the former, disclose a method of melting CIPC to form an aerosol thereof by using a pressurized, hot air stream or a combustion gas stream.

U.S. Pat. No. 6,432,882 granted to Yamamoto discloses a method of atomizing an organic compound such as CIPC wherein the process includes forming minute particles of solid CIPC from a larger block or blocks thereof and introducing the minute particles into an air stream wherein sufficient thermal energy is introduced to convert the particles into an aerosol, that is, by heating the air stream to melt and vaporize the CIPC. Pulverization of the block or blocks of solid CIPC to form the minute particles may be accomplished, for example, by a spinning blade or rapidly spinning turbine blades. U.S. Pat. No. 6,790,469 granted to Robbs et al. discloses a method of treating potato tubers with a powdered organic compound of CIPC wherein a hammer mill or other impact mill pulverizes the solid CIPC into small particles. An air stream which is pressurized and preferably cooled carries the CIPC particles into a separator in which larger particles are separated by gravity and returned to the hammer mill and sufficiently fine particles are carried from the separator via an air duct into a potato storage facility.

US Patent Application Publication 2002/0136839 (Forsythe et al.) discloses a method of forming and delivering an aerosol of solid CIPC by micronizing larger particles thereof with a micronizing device having high speed revolving blades for breaking up the solid particles of CIPC. Preferably, the solid CIPC feed material is kept at temperatures significantly less than its melting point during the micronizing process, which may include the addition of ice to the feed mixture whereby CIPC and ice are both micronized. It is indicated that mixtures of CIPC with other solids such as solid sprout inhibitors, herbicides, fungicides and so forth may be applied by this method. The aerosol formed by the method is directed through a duct and into the storage facility via a distributor which has a cone whereby larger particles which drop out upon entry into the storage facility are collected and such larger particles are blown by a blower through a return duct to the micronizer for further micronization.

Various issues arise with regard to the prior art methods of treating stored crops with an aerosol. One issue relates to the particle size distribution of the particles of the stored crop treatments to be suspended in aerosol form, which is an important factor in effectively and efficiently insuring delivery of the aerosol to the stored crops in a desired manner. Another issue relates to the agglomeration of the stored crop treatment particles such as CIPC in the aerosol. More particularly, a natural feature of aerosols is the collision of particles therein so that the particles agglomerate and become too large to be suspended in aerosol form and thus settle out by force of gravity. In addition, the use of thermal aerosol generators to produce the aerosols creates fire hazards and may cause the thermal breakdown of the chemical treatments at sufficiently high temperatures. These thermal aerosol generators are typically used to heat CIPC to very high temperatures, making the CIPC susceptible even to auto-ignition. Thermal breakdown of the chemical treatment not only reduces the efficiency of delivering the chemical treatment for application to the stored crops, but also may create a new chemical which is not acceptable for use on the crops and which may not be within regulatory requirements, most notably EPA regulations. Another issue is the use of outside air in the aerosol generators, which creates a displacement of air and CIPC or other stored crop treatments out of the crop storage facility and into the environment. This displacement creates environmental pollution issues as well as the loss of the stored crop treatment which could otherwise be utilized for application on the crops.

As noted above, particle size distribution of the particles that make up the aerosols is an important aspect of providing an effective and efficient crop treatment aerosol. However, the prior art patents of which the Applicants are aware utilize grinding methods which will not allow for the production of a particle size distribution which is predominantly within the relatively narrow range of particle sizes required for stored crop aerosols. Often, particle sizes are expressed as a diameter and especially with regard to solid materials may also be expressed as being based on a major dimension of the solid particle. Various methods may be used to measure particle sizes and the number of each size in a particle size distribution. Various size averages can be calculated which may be based either on the number of particles or on weight by using a density of the particle.

One very commonly used size number average is the median average particle size, wherein half of the number of particles are larger and half the number of particles are smaller than a given size measurement. Another common average is the mean average particle size where the particle sizes are totaled and divided by the number of particles. For many purposes, the top size or the amount of larger particles is important. A commonly used average for top size is the size at which 98% of the particle sizes are smaller and 2% of the particle sizes are larger than the given number size. As an example of a number average, one of the smallest size commercially available calcium stearate products is made using a classifier mill to make a mean particle size of 7.5 microns which typically has a 98% top size of 25 microns. This is an example of a wide distribution of particle sizes that is typical. Another top size measurement is the weight amount that passes through a sieve screen of a specified size. For the purposes of this application, the number average sizes will be used.

Wet grinding and dry grinding may be used to pulverize particles and thereby reduce the particle size of solids. With regard to creating stored crop treatment aerosols, dry grinding is the focus. There are at least two problems associated with dry grinding in order to obtain fine particles. One difficulty is plastic deformation and another is the difficulty of stressing fine particles to their breaking point in order to get even finer particles, like those needed to form a stored crop treatment aerosol. Many types of mills may be used in the dry grinding process to produce rather small particles. However, the types of mills that are presently being used in the industry to produce stored crop treatment aerosols are incapable of creating the size particles having a highly desired particle size distribution for producing such aerosols. Two types of mills that are commonly used are hammer mills and jet mills. According to Perry's Chemical Engineering Handbook, Sixth Edition, 1984 at pages 8-14, the limiting particle sizes for hammer mills is in the range of 10-20 microns and for jet mills is 15 microns, meaning that such mills do not produce smaller particles, or do so in a very limited amount.

While the prior art includes the generation of aerosols using particles of CIPC in solid form, thermal aerosol generators are typically used in the industry to vaporize a CIPC formulation in liquid form such as melted CIPC or a CIPC solvent solution. These thermal aerosol generators are capable of producing an aerosol of CIPC particles in liquid form with a desirable particle size distribution. The Ontario Research Foundation of Ontario, Canada, for example, has reported that “in general terms, the order of magnitude of the droplet size has been determined and in all cases of fifteen slides, the number median droplet size was about 1.0 micrometers and the mass median diameter was less than 2.5 micrometers. Results show that, at a constant formulation feed rate, 99% of the droplets are smaller than 4.2 micrometers regardless of combustion chamber operating temperature and position of particle size collected.” (See Report No. QS 306-74-1, dated Jun. 5, 1974). However, as previously noted, creating particles of CIPC or other stored crop treatments in a solid state with a desirable particle size distribution is another matter.

The thermal aerosol generators or thermal foggers previously mentioned present a major disadvantage in that they operate at very high temperatures, which can be a fire hazard and which may also require subsequent cooling to prevent a negative impact on stored crops, which are typically stored within a tightly controlled temperature range. These thermal aerosol generators utilize air taken from outside the crop storage facility and heat the air to a temperature high enough to vaporize the CIPC formulation. Commonly, the CIPC vapor/air mixture has an exhaust temperature ranging from about 700° F. (371° C.) to about 850° F. (454° C.). One of the problems that these high temperatures present is the potential auto-ignition of CIPC or other stored crop treatments. For instance, CIPC and its typical formulations have an auto-ignition temperature of about 734° F. (390° C.). Thus, the CIPC vapor/air mixture exiting the thermal aerosol generator is often well above the auto-ignition temperature of CIPC. The auto-ignition of CIPC and other materials depends on the concentration thereof. Thus, if the concentration of CIPC or a mixture thereof with other combustibles exceeds its lower flammable limit, the CIPC or its mixture can ignite and burn. In addition, the CIPC vapor/mixture greatly exceeds the auto-ignition temperature of many ordinary combustibles such as, for example, paper and wood. The auto-ignition of ordinary combustibles is possibly the single greatest threat of fire to a potato or other crop storage facility. Even if no fire is caused in the manner described above, the thermal aerosol generators may still subject the CIPC or mixture thereof to temperatures which may cause thermal breakdown of the CIPC so that the amount of CIPC available for application to the stored crops is reduced and the formulation resulting from the thermal breakdown may not be acceptable for application to the crops.

In addition, thermal aerosol generators and other aerosol generators utilize outside air to produce the aerosol which is introduced into the storage facility for application of the crop treatment to the crops. This presents another disadvantage in that the introduction of the outside air causes displacement of air and CIPC or the like from the storage facility. Thus, CIPC is exhausted into the environment, thus contributing to pollution and reducing the overall efficiency of the system.

The present invention addresses these and other problems as will become more evident from the detailed description of the invention.

### BRIEF SUMMARY OF THE INVENTION

The present invention provides a method comprising the steps of generating a stored crop treatment aerosol comprising a plurality of components each comprising a solid carrier and a stored crop treatment attached to the carrier; and moving the aerosol in atmosphere in which crops are stored to apply a portion of the crop treatments to the stored crops.

The present invention also provides a composition comprising a plurality of components each comprising: a solid carrier; and a stored crop treatment attached to the carrier wherein the components are of a size suitable to form a stored crop treatment aerosol of the components.

The present invention further provides a method comprising the steps of supplying to an aerosol generator a composition comprising a plurality of components at least 80% of which have a particle size value no greater than 10.0 microns wherein the components comprise a plurality of solid stored crop treatments; generating with the aerosol generator a stored crop treatment aerosol of the composition; and moving the aerosol in atmosphere in which crops are stored to apply a portion of the crop treatments to the stored crops.

The present invention further provides a composition comprising a plurality of components at least 80% of which have a particle size value no greater than 10.0 microns wherein the components comprise a plurality of solid stored crop treatments.

### BRIEF DESCRIPTION OF THE SEVERAL VIEWS OF THE DRAWINGS

FIG. 1 is a diagrammatic view of the system or apparatus of the present invention, and indicates generally the movement of the materials used to make the composition of the present invention and the movement of the composition in the generation of a stored crop treatment aerosol and application thereof to stored crops.

FIG. 2 is an elevational view of a type of blender that can be used with the present invention.

FIG. 3 is a sectional view of a type of grinder that can be used with the present invention as seen from the side.

FIG. 3A is a diagrammatic view of a plurality of particles of one type of composition of the present invention.

FIG. 3B is a diagrammatic view of a particle of another type of composition of the present invention.

FIG. 3C is a diagrammatic view of the particle size distribution of the composition produced by the grinder of the present invention.

FIG. 4 is a sectional view of a type of feeder that can be used with the present invention as viewed from the side.

FIG. 5 is a sectional view of a type of air pump that can be used with the present invention.

FIG. 6 is a sectional view of a type of aerosol generator that can be used with the present invention.

FIG. 7 is a diagrammatic sectional view of a crop storage facility with crops stored therein.

Similar numbers refer to similar parts throughout the specification.

### DETAILED DESCRIPTION OF THE INVENTION

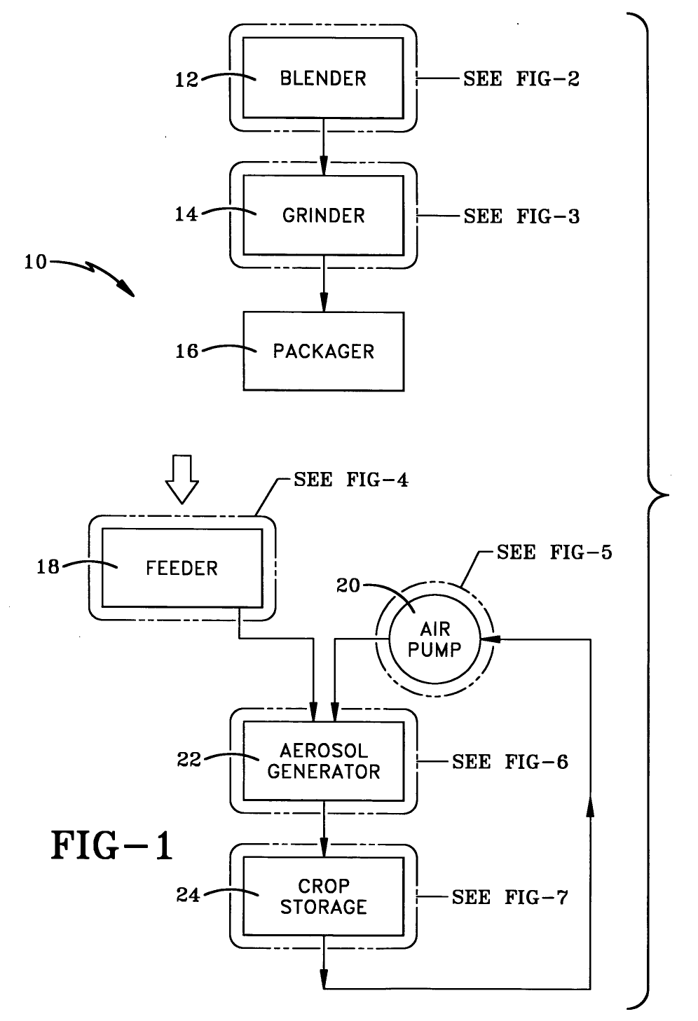

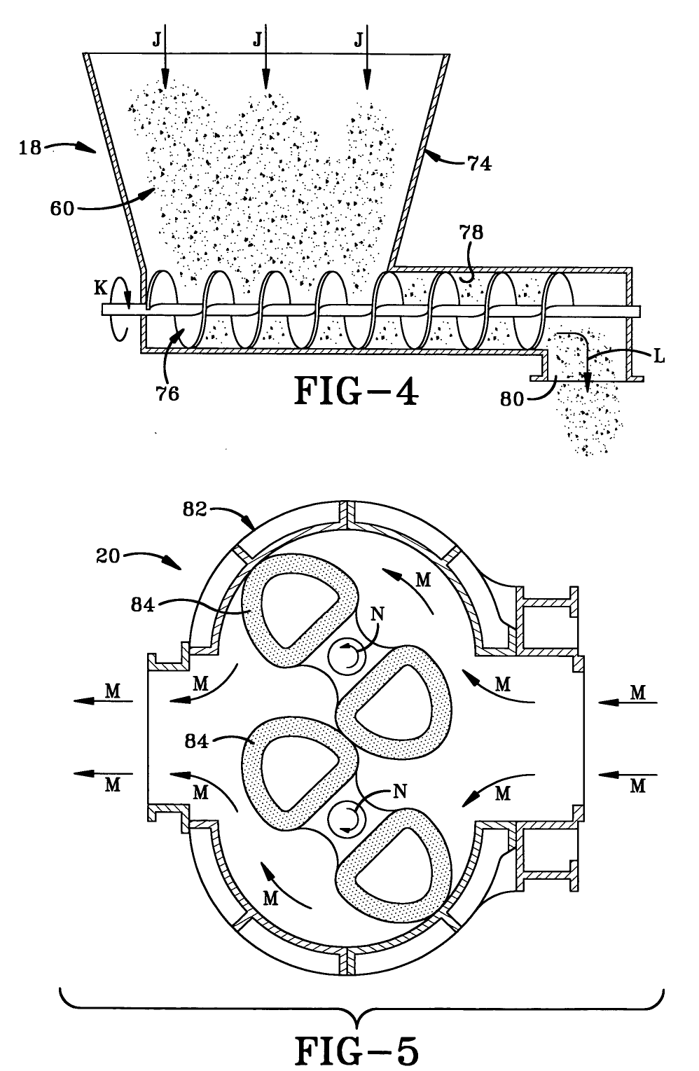

The system or apparatus of the present invention is indicated generally at 10 in FIG. 1. Apparatus 10 includes a blender 12, a grinder 14, a packager 16, a feeder 18, a blower in the form of an air pump 20, an aerosol generator 22 and a crop storage facility 24. In general, blender 12 and grinder 14 are used to form a composition 60 (FIG. 3) which will be used in an aerosol form for application thereof to stored crops to treat them for any desired purpose. Packager 16 then packages the composition so that it is ready for delivery and use in the production of a stored crop treatment aerosol 116 (FIGS. 6-7). Feeder 18, pump 20 and aerosol generator 22 are used to produce stored crop treatment aerosol 116 comprising composition 60 produced by blender 12 and grinder 14 for delivery to crop storage facility 24 in order to treat crops stored therein.

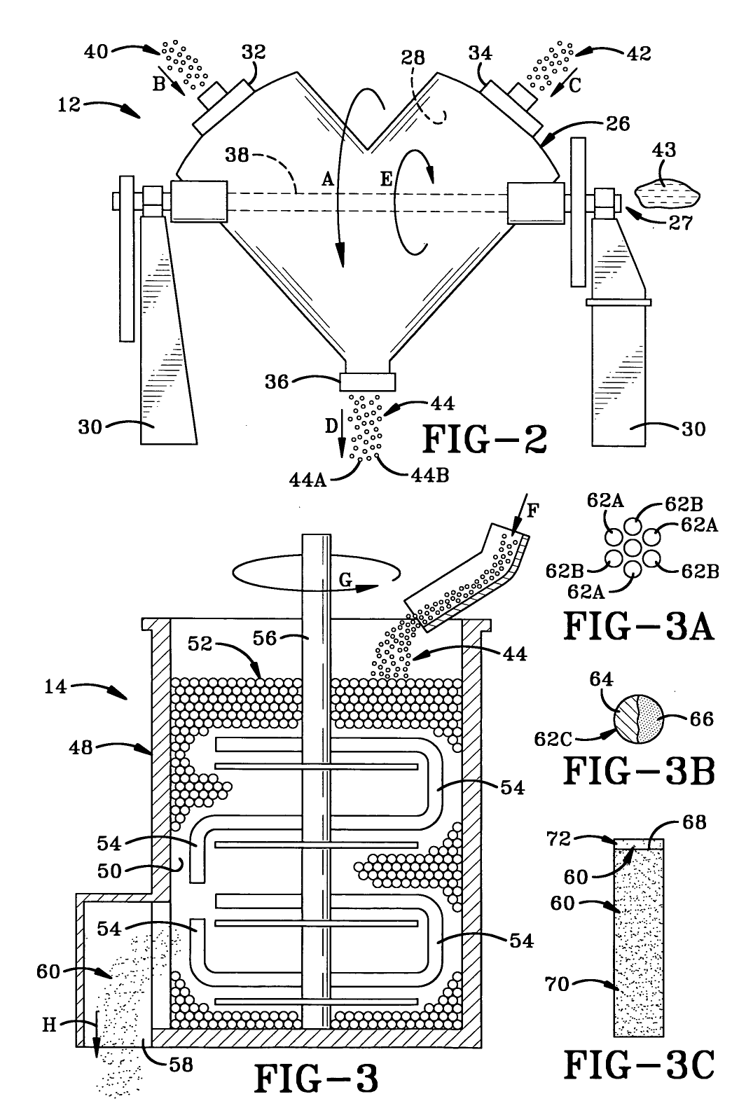

With reference to FIG. 2, one type of blender 12 is shown in greater detail. Blender 12 is also known as a tumbler and is used for the mixing of materials to include the mixing of solids or the mixing of solids and liquids. Blender 12 includes a mixing vessel 26 which defines an interior mixing chamber 28 and which is mounted on and between a pair of supports 30 in a rotatable fashion, as indicated by Arrow A. Mixing vessel 26 has first and second feed ports 32 and 34 for feeding or charging materials to be mixed into mixing chamber 28, as indicated by Arrows B and C. Blender 12 further has an exit port 36 for releasing the mixture of materials from mixing chamber 28, as indicated at Arrow D. Blender 12 further includes an interior blending structure 38, which is typically used for the breaking up of agglomerates and may also double as a liquid feeding device. Alternately, structure 38 may be either one of an agglomerate breaking device and a liquid feeding device. When used as a liquid feeding device, liquid is fed via a liquid feed port 27. Blending structure 38 rotates as indicated by Arrow E in a direction which is opposite to the rotation of mixing vessel 26.

Solid pieces 40 of a selected material or materials are fed as indicated at Arrow B into mixing chamber 28 of mixing vessel 26 and stored crop treatment pieces 42 are fed as indicated at Arrow C into mixing chamber 28 in order to mix pieces 40 and 42 to produce a mixture 44 of solid particles 44A derived from solid pieces 40 and stored crop treatment particles 44B derived from pieces 42, as shown exiting via exit port 36 from chamber 28 at Arrow D. It is noted that solid pieces 40 may be formed entirely of or include a solid stored crop treatment material. It is further noted that while pieces 42 are discussed in terms of solid pieces, a liquid 43 at ambient temperatures may also be used alone or in combination with solids to be mixed with solid pieces 40. Any liquid components that need to be added are added to the rotating blender through port 27 in order to disperse the liquids onto the solids. CIPC is most usefully dispersed as a liquid. While the mixing of pieces 40 and 42 in blender 12 may produce some reduction in size of said pieces, blender 12 is primarily used for mixing pieces 40 and 42 together and to break down agglomerates thereof without or substantially without breaking down the size of individual solid pieces. As further detailed below, pieces 40 and 42 are ultimately broken down into smaller counterparts derived therefrom which will ultimately be of the size which is suitable for forming a stored crop treatment aerosol for application to stored crops. Generally, the components of a formulation are mixed in this step so that they can be ground to the required size in the next step. For some chemical formulations, however, no further grinding may be required. Thus, where solid particles are already at the desired particle size distribution detailed further below, the blending of the various particles such as 40 and 42 and/or liquid 43 in blender 12 may at this stage produce composition 60 (FIG. 3) without further grinding or other subsequent steps.

Pieces 40 and 42 and/or liquid 43 are selected from materials which will of course be safe for the treatment of stored crops. In addition, solid pieces 40 are selected to provide specific characteristics in the composition used for forming the stored crop treatment aerosol. For example, solid pieces 40 may be selected specifically to help prevent combustion of the aerosol and to provide resistance to caking of composition 60. Some examples of materials that will provide non-combustibility and anti-caking properties are attapulgus clay, which is commonly called attapulgite; silica; diatomite or diatomaceous silica; and zinc oxide. Silica in particular is preferred with regard to its anti-caking characteristics. Limestone with suitable particle size is also available and will provide noncombustibility. Suitable organic solids such as pecan hulls may also be ground to the suitable particle size for use in the formulation. Pecan hulls are amongst a variety of solids approved by the EPA for use with pesticides.

Some of the materials from which solid pieces 40 may be formed are commercially available at sizes which are suitable for use in a stored crop treatment aerosol, and in particular which have a particle size distribution comparable to that discussed below with regard to composition 60 produced by ball mill 14 (FIG. 3). For example, attapulgite is available from Engelhard Corp., of Iselin, N.J. and also from Floridin Division of ITC Industries of Quincy, Fla. In addition, diatomite is available from Grefco Inc. of Los Angeles, Calif. Precipitated silicas are available from PPG Industries of Pittsburgh, Pa.

Solid pieces 40 may be a single composition, which may include the non-combustible and/or anti-caking characteristics, or pieces 40 may include more than one material, one or more of which may include the non-combustible and/or anti-caking characteristics. Stored crop treatment pieces 42 may be formed of one or more materials useful as a growth or sprout retardant (such as CIPC), a pesticide, a sterilant, a disinfectant or the like. Preferably, all of solid pieces 40 are formed of technically pure solids, chemicals, or chemical combinations. Likewise, stored crop treatment pieces 42 are preferably formed of technically pure chemicals or chemical combinations and liquid 43 is preferably a technically pure liquid or liquids.

After blending, and with reference to FIG. 3, mixture 44 of solid particles 44A and stored crop treatment particles 44B (solid or liquid) are fed as indicated at Arrow F into grinder 14 in the form of a non-rotary ball mill or bead mill. Ball mill 14 includes a container 48 defining a grinding cavity 50 which is filled to a certain level with grinding media 52. Grinding media 52 include a plurality of small balls or beads for grinding materials into very small particle sizes. Ball mill 14 further includes a plurality of rotating arms 54 rigidly mounted on a rotating shaft 56 which rotates as indicated by Arrow G in order to rotate arms 54. While FIG. 3 shows grinding media 52 spaced from rotating arms 54 and rotating shaft 56 in order to show those structures with greater clarity, in reality, grinding media 52 completely fills grinding cavity 50 from the bottom thereof up to the upper level of grinding media 52, and thus some of media 52 are in contact with arms 54 and shaft 56. Ball mill 14 further defines an exit opening 58. A suitable non-rotary ball mill 14, also known as an attritor, is available from Union Process of Akron, Ohio. The ball mill 14 is also known as a stirred type, being stirred by arms 54, and may also be of a vibratory type, wherein vibrations provide an alternate means of introducing the energy to media 52 to grind the particles. Non-rotary ball mill 14 is distinguished from a rotary ball mill which utilizes a container which is rotated with grinding material inside, such as is commonly used in the polishing of stones. Rotary ball mills have been used particularly for wet grinding systems and were previously used commonly in the mixing of paints. While a rotary ball mill may be capable of producing the particle size distribution desired with the present invention, it would nonetheless be substantially slower and thus less practical.

Once mixture 44 of particles 44A and 44B are fed into grinding chamber 50 of ball mill 14, rotating shaft 56 is rotated to rotate arms 54, which hit grinding media 52 to move media 52 forward rapidly. Media 52 then collide with other media 52 and particles 44A and 44B to break up particles 44A and 44B into smaller and smaller particles. Thus, rotating arms 54 agitate media 52 and provide the energy to grind the particles present. This process continues until the particles ultimately exit via exit opening 58, as indicated at Arrow H, at the desired size suitable for forming stored crop treatment aerosol 116 (FIGS. 6-7).

With reference to FIGS. 3A-3B and in accordance with a feature of the invention, the breakup of particles 44A and 44B by ball mill 14 (FIG. 3) results in very fine particles derived from particles 44A and very fine particles derived from particles 44B which may be respectively attached to the very fine particles derived from particles 44A. More particularly, the result is composition 60, which in part falls into two broad categories, with a notable exception detailed later. One category involves a composition 60 which includes a mixture (FIG. 3A) of solid particles 62A derived from particles 44A and solid treatment particles 62B derived from particles 44B which are not attached to the solid particles derived from particles 44A. The other category involves a composition 60 which includes a plurality of particles or components 62C each comprising a solid carrier 64 and a stored crop treatment 66 (solid or liquid) attached thereto, wherein solid carriers 64 are derived from solid particles 44A and stored crop treatments 66 (which may include CIPC) are derived from stored crop treatment particles 44B or liquid 43. As previously noted, pieces 40 and pieces 42 may each be formed of one or more materials and liquid 43 may be of a single chemical or a combination of chemicals. Thus, the corresponding particles derived therefrom may also include one or more different materials. More particularly, solid particles 62A may be of a single material or of multiple materials and this is likewise true of solid treatment particles 62B, solid carriers 64 and crop treatments 66. As noted earlier, some of the material from which solid pieces 40 are formed may be provided in the particle size distribution which would normally be produced by ball mill 14. Thus, because particles 44A are derived from solid pieces 40, where such a material is used which is already broken down to the desired particle sizes, ball mill 14 will not substantially break up particles 44A, but will nonetheless break up particles 44B and provide the process by which solid carriers 64 and stored crop treatments 66 are attached to one another to form components 62. In the case where stored crop treatments 66 are liquids, they are attached to carriers 64 by absorption or adsorption.

Each particle 62 has a particle size value which typically ranges from 1 to 10 microns and more preferably from 1 to 5 microns. More importantly, however, as detailed below, ball mill 46 produces a composition 60 which has a highly desirable particle size distribution for use in stored crop treatment aerosol 116. In contrast to the prior art methods mentioned in the Background section of this application, ball mill 14 produces a highly desirable particle size distribution of particles 62 without the use of or without passing particles 62 through a particle size classifier. Thus, there is no need to recycle larger particles which have been discharged from ball mill 14 in order to regrind them to produce the particle size distribution discussed below.

In accordance with another feature of the invention, FIG. 3C diagrammatically indicates the particle size distribution of particles 62 of composition 60. More particularly, a top size line 68 represents a line of division whereby a certain percentage of particles 62 have a particle size which is smaller than a given value represented by line 68 and a certain percentage of particles 62 have a particle size which is larger than the given value. Said smaller particles are indicated at 70 and said larger particles 62 are indicated at 72. Composition 60, as produced by ball mill 14, preferably has a top size line value ranging from 80% to 98% although lower percentages may be used such that composition 60 still provides a substantially improved particle size distribution. Thus, for instance, top size line 68 may represent 80%, 90%, 95% or 98%, with the higher percentages being more preferred in terms of providing a more desirable composition 60. Thus, for example, composition 60 preferably has a 80% top size line 68 no greater than 10.0 microns, indicating for purposes of the present application that at least 80% of particles or components 62 of composition 60 have a particle size value which is smaller than 10.0 microns. Preferably, 80% top size line 68 is no greater than 8.0 microns, indicating that at least 80% of particles 62 of composition 60 are smaller than 8.0 microns. More preferably, 80% top size line 68 is no greater than 5.0 microns, indicating that at least 80% of particles 62 of composition 60 are smaller than 5.0 microns. Similarly, composition 60 may have, for example, 90%, 95%, or 98% top size line 68, indicating a like relationship of particle size with respect to each of these percentages. In particular, these particle size distributions are in accordance with measurements made by a laser light scattering particle size distribution analyzer. Such an analyzer is available from USA Horiba Jobin Yvon Inc., Edison, N.J. Also suitable are the MICROTRAC analyzers made by Microtrac Inc., Montgomeryville, Pa.

Once the grinding process is completed, composition 60 is fed into a packager 16 (FIG. 1) for packaging and subsequent shipment to the site of a crop storage facility. While it is clearly possible to achieve the blending and grinding steps of the process on site with the crop storage facility, the high cost of non-rotary ball mills such as ball mill 14 and regulatory requirements will generally mean that the grinding process will be completed offsite from the crop storage facility.

Whether or not composition 60 is packaged at the crop storage facility site or another location, the next step of the process is feeding composition 60 into feeder 18, as indicated at Arrows J in FIG. 4. Feeder 18 is more particularly a screw feeder which includes a hopper 74 for receiving composition 60 and a screw 76 which is rotatable as indicated at Arrow K for moving composition 60 through a lateral passage 78 and out of an exit opening 80 as indicated by Arrow L in order to feed composition 60 into aerosol generator 22, as further detailed below.

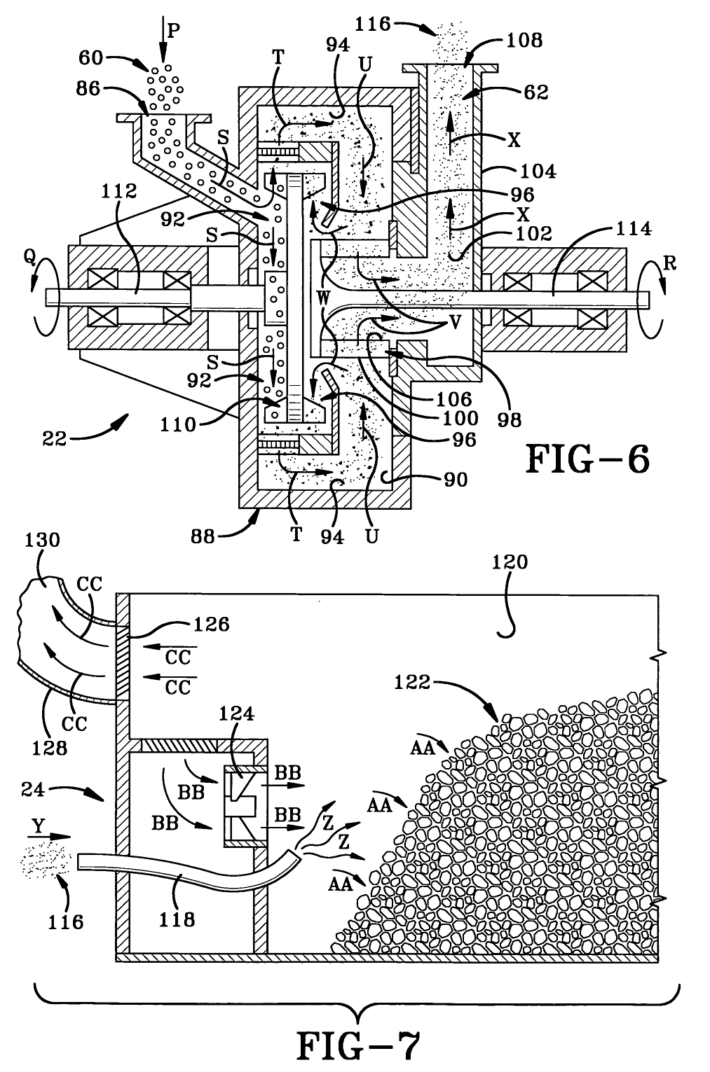

In conjunction with the feeding of composition 60 from feeder 18 into aerosol generator 22 and with reference to FIG. 5, air pump 20 is used to move air or another gas into aerosol generator 22, as indicated by Arrows M in FIG. 5. As will be discussed further below, pump 20 moves air from crop storage 24 into aerosol generator 22, as illustrated in FIG. 1. More particularly, pump 20 is a two-impeller type rotary positive-displacement blower which includes a housing 82 and a pair of impellers 84 which respectively rotate in opposite directions as indicated by Arrows N in order to move air along the path indicated by Arrows M.

With reference to FIG. 6, composition 60 is fed from feeder 18 and air or another gas is pumped by air pump 20 into an inlet 86 of aerosol generator 22 as indicated by Arrow P. Thus, pump 20 provides an airstream or gas stream which moves through aerosol generator 22 with composition 60 entrained in the airstream. More particularly, aerosol generator 22 is a classifier mill which includes a housing 88 defining an interior chamber 90. Interior chamber 90 is divided into a first stage grinding area 92 which is in fluid communication with inlet 86. Interior chamber 90 further includes a transit passage 94 which is in fluid communication with grinding area 92, and also includes a second stage grinding area 96 in fluid communication with transit passage 94. Transit passage 94 is also in fluid communication with a cylindrical particle size classifier 98 along an entry side 100 thereof. An exit passage 102 is formed partially within interior chamber 90 and partially externally thereto within an outlet duct 104. Exit passage 102 is in communication with classifier 98 along an exit side 106 thereof and with an exit opening 108 of outlet duct 104. Aerosol generator 22 further includes a grinding rotor 110 which is mounted on a rotatable first shaft 112 whereby rotation of first shaft 112 as indicated by Arrow Q rotates grinding rotor 110. Grinding rotor 110 is disposed within first and second grinding areas 92 and 96. Classifier 98 is mounted on a second rotatable shaft 114 which is rotatable as indicated at Arrow R whereby classifier 98 is rotatable.

With continued reference to FIG. 6, it is first noted that composition 60 when fed into inlet 86 of aerosol generator 22 will typically have agglomerated to one degree or another. However, grinder 14 has already performed the function of breaking down larger particles of composition 60 at the very fine particle sizes previously noted. Thus, aerosol generator 22 is used at this stage of the process to simply break apart any agglomerated particles of composition 60 and disperse them within an airstream in order to produce stored crop treatment aerosol 116. This breaking up of any agglomerates and the dispersion thereof requires relatively little energy at this point so that any machine that may be used for particle size reduction and/or that is capable of being operated at conditions that will disperse the agglomerates is suitable for this purpose, whether or not a classifier is used. More particularly, composition 60 moves from inlet 86 in what will typically be an agglomerated form into first stage grinding area 92 as indicated by Arrows S, where grinding rotor 110 performs a first stage grinding of composition 60 to break up or disperse any of composition 60 which has agglomerated and moved them into transit passage 94, as indicated at Arrows T. At this stage, some and typically most if not all of particles 62 have been separated back out into the very fine particles produced by grinder 14 while some of particles 62 may remain in an agglomerated form, as indicated respectively by the small and large dots within transit passage 94 in FIG. 6.

After moving through transit passage 94 as indicated at Arrow U, the smaller particles or components 62 will pass through classifier 98 and into exit passage 102 as indicated at Arrows V and the larger or agglomerated particles or components 62 will move from passage 94 into second stage grinding area 96 as indicated by Arrows W. These agglomerated particles will then be separated by grinding rotor 110 in grinding area 96 and then moved back into transit passage 94 as indicated by Arrows T, so that when the particles are small enough they will pass through classifier 98 and into exit passage 102. Particles 62 then move within exit passage 102 as indicated by Arrows X out through exit opening 108 as stored crop treatment aerosol 116. Because particles 62 were so finely ground by grinder 14, the use of aerosol generator 22 to disperse particles 62 allows them to pass through classifier 98 with relative ease and allows for the use of a classifier 98 which allows the passage of particles which have a particle size value no greater than, for instance, 10 microns, 8 microns, 5 microns or even smaller.

Thus, because grinder 14 produced particles 62 at the highly desirable particle size distribution previously discussed, aerosol generator 22 may generate stored crop treatment aerosol 116 wherein the particle size distribution of components 62 within aerosol 116 is such that at least 80% to 98% of components 62 have a particle size value which is no greater than 10.0 microns, and may be no greater than 8.0 microns or 5.0 microns. Because of such highly desirable particle size distributions, composition 60 may be dispersed at an ambient or cooler-than-ambient temperature, thermal aerosol generation no longer being required to produce the desirable particle size distribution. Thus, composition 60 may be utilized to produce aerosol 116 without adding heat to the airstream which will be delivered to crop storage facility 24. However, composition 60 also allows for aerosol generation at higher-than-ambient temperatures.

With reference to FIG. 7, aerosol 116 then moves as indicated by Arrow Y via a duct 118 and into atmosphere 120 within crop storage facility 24 as indicated by Arrows Z and into spaces between stored crops 122 within storage facility 24, as indicated at Arrows M, whereby particles 62 are applied to the surfaces of stored crops 122 in order to treat crops 122 with stored crop treatment particles 62B or treatments 66. Of course, where particles 62A of the mixture shown in FIG. 3A and carrier 64 are formed of stored crop treatment material, they will also be considered treatments for treating crops 122. Crop storage facility 24 includes a fan 124 for recirculating air or other atmosphere 120 within facility 24 as indicated by Arrows BB. Storage facility 24 further includes a vent 126 with an exit duct 128 which defines a passage 130 and is mounted on facility 24 whereby atmosphere 120 is in fluid communication with passage 130 via vent 126. Duct 128 is in fluid communication with inlet 86 of aerosol generator 22 (FIG. 6) whereby atmosphere 120 along with a portion of particles 62 in aerosol form move from within storage facility 24 into passage 130, as indicated by Arrows CC in FIG. 7 and, via air pump 20, back into inlet 86 of aerosol generator 22 as indicated by Arrow P in FIG. 6. Thus, while crop storage facilities used in the industry currently vent atmosphere into the external environment, the present invention maintains a substantially closed system wherein, as most easily seen in FIG. 1, storage air from crop storage facility 24 is pumped via air pump 20 into aerosol generator 22 and then back into storage facility 24 without or substantially without venting air or particles 62 into the environment external to apparatus 10.

Thus, apparatus 10, the method of using the same and composition 60 provide solutions to the various problems indicated in the Background section of the present application. More particularly, the use of grinder 14 allows for a particle size distribution of composition 60 which is vastly superior to those presently used in the industry. This allows for the dispersion of stored crop treatments via any type of aerosol generator that is capable of being operated at conditions that will disperse the agglomerates. While it is preferred that a classifier be used with the aerosol generator, whether internal or external thereto, nonetheless the particle size distribution provided by grinder 14 already provides an improvement in the effective dispersion of stored crop treatments into an aerosol form for application to store crops. As previously noted, composition 60 allows for the production of a stored crop treatment aerosol at ambient or cooler temperatures so that thermal stability of the stored crop treatments within composition 60 is not a problem. While the previous discussion has focused on stored crop treatments which are chemical compounds such as organic compounds, it is noted that the ability to produce aerosols at these lower temperatures also allows the stored crop treatments to be biological compounds as well.

In addition, the use of a solid carrier 64 or solid particle 62A provides a variety of advantages. First, the use of solid carriers 64 or particles 62A may greatly reduce caking of stored crop treatments, which typically occurs upon exposure to moisture or in response to temperature changes. More particularly, caking is the development of crystals between particles so that the particles become chemically combined. With regard to stored crop treatments which are susceptible to caking, it is important to eliminate or minimize caking so that, particularly during storage, composition 60 remains at the highly desired particle size distribution for use in generating the stored crop treatment aerosol. Components which provide an anti-caking characteristic are very useful to make good compositions with acceptable shelf-life. With particular regard to CIPC, this is a great advantage in that even at ambient and somewhat cooler temperatures, CIPC is a waxy substance which has a strong tendency to cake. More specifically, components 62C may have a caking tendency with respect to one another which is less than that of the stored crop treatments 66 alone with respect to one another. Similarly, the mixture shown in FIG. 3A of particles 62A and 62B may have a caking tendency which is less than that of stored crop treatment particles 62B.

Another use is that solid carriers allow liquids to be made into chemical formulations that have the characteristics of solids. Thus, the use of solid carriers with liquid stored crop treatments attached thereto allows the liquid treatments to be separated out as if they were solid particles in order to produce the highly desired particle size distribution described herein. Thus, a liquid stored crop treatment can be divided into the desired particle size via the use of a solid carrier prior to feeding the liquid treatment into an aerosol generator. This is in contrast to the thermal aerosol generators, which require that the generator itself vaporize such liquid treatments in order to disperse them at a desired particle size distribution.

In addition, the use of solid carriers 64 or particles 62A may include solids which are noncombustible so that even when used with a combustible stored crop treatment such as CIPC, the crop treatment will become noncombustible when in aerosol form. While composition 60 allows for aerosol generation at relatively low temperatures, including ambient or cooler temperatures, a sufficient amount of the solid carriers or other noncombustible solid particles can make the stored crop treatment noncombustible in aerosol form even at substantially higher temperatures, such as, for example, those associated with thermal aerosol generators. It is noted that even when aerosol generators operate at ambient or cooler temperatures, many stored crop treatments are potentially combustible, as they are typically organic compounds.

In general, stored crop treatments using combustible organic compounds such as CIPC in aerosol form are susceptible to combustion or explosion when the treatments are above the lower explosive limit upon exposure to a spark or flame or when the treatments reach their auto-ignition temperature. For example, CIPC has an auto-ignition temperature of about 427° C. The use of a suitable composition 60 having a sufficient degree of noncombustible solids therein can prevent combustion or explosion of the stored crop treatment aerosols, whether due to ignition by a spark or flame or reaching their auto-ignition temperature. Thus, for example, the use of a suitable composition 60 allows a stored crop treatment aerosol to be generated at an aerosol concentration which is equal to or greater than the lower explosive limit of the stored crop treatments when used alone in aerosol form whereby the stored crop treatment aerosol of composition 60 is configured to prevent combustion due to the exposure of the stored crop treatments to a spark or flame at the aerosol temperature. Thus, even at relatively low aerosol temperatures, a noncombustible aerosol of composition 60 can prevent fire hazards due to, for example, exposure of the aerosol to sparks from motors, electrical controls and the like.

Finally, the use of a closed system in terms of the circulation of air and aerosol within the crop storage facility and the aerosol generator keeps the air or other gas and the stored crop treatment within the closed system to increase the efficiency of delivering the stored crop treatment to the stored crops and to prevent the displacement thereof into the external environment and thus prevent pollution in said environment.

In general, the components of apparatus 10 may be interchanged with other like components without substantially affecting the operation of the invention. For example, any suitable blender may be used in place of blender 12 and any suitable type of feeder, aerosol generator and blower or pump may be respectively used in place of feeder 18, aerosol generator 22 and air pump 20. Aerosol generator 22 may, for example, be a venturi, a turbine (such as disclosed in U.S. Pat. No. 6,432,882 granted to Yamamoto), a pin mill, a cage mill, a hammer mill or a fluid energy or jet mill. Suitable hammer mills includes fine grinding mills by Condux (Hanau, Germany), Reitz disintegrators (Hosokawa Micron, Summit, N.J.), Praeter fine grinder mills (Cicero, Ill.) and Kek fine grinding mills (Kemutec Group of Bristol, Pa.). These hammer mills are available with integral particles size classifiers although separate particle classifiers are also available. Fluid energy mills include Micron-Master (Jet Pulverizer Company of Moorestown, N.J.), Jet-O-Mizer (Fluid Energy Processing & Equipment, Telford, Pa.) and Trost Mills (Colt Industries). These fluid energy mills have integral classifiers.

However, it is noted that grinder 14 in the form of a non-rotary ball mill or bead mill is highly preferred because of its ability to grind the materials into a preferred particle size distribution in a relatively efficient manner. It is emphasized also that the grinders which have been used within the industry of stored crop treatment aerosols simply cannot produce this degree of particle size distribution.

It is further noted that while the present invention has thus far been described with regard to the use of a composition 60 of solid particles 62A and treatment particles 62B (FIG. 3A) and a composition 60 of solid carriers 64 and stored crop treatments 66 attached thereto with the highly desired particle size distribution disclosed herein, the invention also includes the formation of solid stored crop treatments 62B which alone fall within the specific particle size distributions previously discussed with regard to particles 62. That is, the invention also includes the use of solid stored crop treatments 62B without attachment to solid carriers 64 or mixture with solid particles 62A, wherein treatments 62B have said desired particle size distribution so that the stored crop treatments may be formed alone and used to generate a stored crop treatment aerosol for delivery to a storage facility such as storage facility 24.

More particularly, stored crop treatment pieces 42 of a suitable size may be fed directly into ball mill 14 or another similar grinder in order to produce solid stored crop treatments 62B which alone fall within the particle size distributions previously detailed. Such stored crop treatments 62B may then be fed into an aerosol generator such as aerosol generator 22 and dispersed in a suitable fashion in order to generate a stored crop treatment aerosol for delivery to a crop storage facility in order to treat stored crops therein. Depending on the particular material of which stored crop treatments 62B are formed, said aerosol may be generated at ambient or cooler temperatures or at higher-than-ambient temperatures.

In addition, it is noted that crop storage facility 24 is adapted for return air coming therefrom to aerosol generator 22. Standard storage facilities simply vent into the external atmosphere.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
supplying to an aerosol generator a composition comprising a plurality of components at least 80% of which have a particle size value no greater than 10.0 microns wherein the components comprise a plurality of solid stored crop treatments;
generating with the aerosol generator a stored crop treatment aerosol of the composition; and
moving the aerosol in atmosphere in which crops are stored to apply a portion of the crop treatments to the stored crops.

2. The method of claim 1 wherein the step of supplying includes the step of supplying a plurality of components all of which are solid stored crop treatments.

3. The method of claim 2 wherein the step of supplying includes the step of supplying a plurality of components all of which are solid stored crop treatments comprising one or more chemicals each of which is technically pure.

4. The method of claim 1 wherein the step of supplying includes the step of supplying a plurality of the components including a plurality of additional solid particles.

5. The method of claim 1 wherein the step of supplying includes the step of supplying to the aerosol generator a composition which includes CIPC.

6. The method of claim 1 wherein the step of generating includes the step of
generating the stored crop treatment aerosol with one of a venturi, a turbine, a pin mill, a cage mill, a hammer mill and a fluid energy mill.

7. The method of claim 1 wherein the step of generating includes the step of generating the stored crop treatment aerosol substantially without reducing the size of the components.

8. The method of claim 1 further including the step of grinding a plurality of solid particles in a non-rotary ball mill to form the plurality of components at least 80% of which have a particle size value no greater than 10.0 microns.

9. The method of claim 1 further including the step of grinding with a grinder a plurality of solid particles to form the plurality of components at least 80% of which have a particle size value no greater than 10.0 microns without re-grinding with the grinder particles which have been discharged therefrom.

10. The method of claim 1 wherein the step of generating includes the step of generating at an ambient or cooler-than-ambient temperature.

11. The method of claim 1 wherein the step of generating includes the step of generating a stored crop treatment aerosol including a plurality of solid particles in an amount sufficient to make the aerosol non-combustible.

12. The method of claim 1 wherein the step of supplying includes the step of supplying to an aerosol generator a composition consisting of a plurality of components at least 90% of which have a particle size value no greater than 10.0 microns wherein the components comprise a plurality of solid stored crop treatments.

13. The method of claim 1 wherein the step of supplying includes the step of supplying to an aerosol generator a composition consisting of a plurality of components at least 95% of which have a particle size value no greater than 10.0 microns wherein the components comprise a plurality of solid stored crop treatments.

14. A composition comprising:
a plurality of components at least 80% of which have a particle size value no greater than 10.0 microns wherein the components comprise a plurality of solid stored crop treatments.

15. The composition of claim 14 wherein all of the components are solid stored crop treatments.

16. The composition of claim 15 wherein the solid stored crop treatments comprise one or more chemicals each of which is technically pure.

17. The composition of claim 14 wherein the plurality of the components include a plurality of additional solid particles.

18. The composition of claim 14 wherein the components include a plurality of additional solid particles whereby the composition has a caking tendency which is less than that of a composition of the stored crop treatments alone.

19. The composition of claim 14 wherein the composition comprises a plurality of solid particles which have anti-caking characteristics and are present in an amount sufficient to substantially eliminate caking of the composition.

20. The composition of claim 14 wherein the composition includes at least one of attapulgite, diatomite, silica, limestone and zinc oxide.
